(19) United States
(12) Patent Application Publication
(10) Pub. No.: US 2026/0126607 A1
(43) Pub. Date: May 7, 2026

(54) CHIP FOR FIBER DEMARCATION BOX

(71) Applicant: Hubbell Incorporated, Shelton, CT (US)

(72) Inventor: Adam Joseph Clark, Greenville, SC (US)

(21) Appl. No.: 19/382,674

(22) Filed: Nov. 7, 2025

Related U.S. Application Data
(60) Provisional application No. 63/717,517, filed on Nov. 7, 2024.

(51) Int. Cl. G02B 6/44

(52) U.S. Cl. CPC G02B 6/4447; G02B 6/445; G02B 6/4454

(57) ABSTRACT

A holding device includes a body, a first plurality of retainer arms arranged in a first row, and a second plurality of retainer arms arranged in a second row. The first plurality of retainer arms each includes a first upper edge and a first lower edge. The second plurality of retainer arms each includes a second upper edge and a second lower edge. A free end of the lower edge in each of the first plurality of retainer arms is disposed a first distance from a surface of the body and a free end of the second lower edge in each of the second plurality of retainer arms is disposed a second distance from the surface that is greater than the first distance. Movement of each arm of the first plurality of retainer arms is independent of the movement of each arm of the second plurality of retainer arms.

### CROSS-REFERENCE TO RELATED APPLICATION

This application claims the benefit of U.S. Provisional Application No. 63/717,51, filed Nov. 7, 2024, the contents of which is incorporated herein by reference in its entirety.

### FIELD

The present disclosure relates to cable management devices, such as network interface devices (NIDs).

### BACKGROUND

Network interface devices (NID) are enclosures installed on premises to serve as a demarcation point between premise and utility wiring (e.g., in fiber optic telecommunication applications). Fiber NIDs, also known as fiber distribution boxes (FDB), typically provide for the enclosure of fiber splices made in the field. A finished splice can be enclosed in a splice protection sleeve which can include a piece of heat shrink tubing and may also include a wire reinforcement. A typical protection sleeve may be, for example, about 0.10 to about 0.12 inches in diameter and about 2.5 inches long after application. Typically, two splices are required for each fiber service, and each NID may be required to enclose many splices. The NID can provide a means to keep all of these splices secure and organized. Such a means may be incorporated into a larger panel within the NID, or include a separate piece, in which case it may be referred to as a splice chip.

A splice holder or splice chip device typically secures all splices closely together. A multitude of methods have been used to secure fiber splices. Some examples of splice chips may be constructed from rubber and designed so that the user may press each splice in through a slight interference fit. Other examples of splice holders may have vertical walls or posts as dividers between the splices and use a rubber piece secured to the top for retention after splices are laid in. These examples of splice holders generally include a single row. For example, a rubber chip may not provide sufficient stiffness to accommodate a second row (e.g., an upper row).

Some examples of splice holders may be double row splice holders and include a series of vertically oriented snaps disposed in the space between splices. This configuration may not accommodate tolerances and variation in the splice diameter, because each splice is captured directly between two sets of snaps (i.e., may not have sufficient degrees of freedom to grip all splices uniformly). Therefore, there is a need for a multi-row splice chip to capture a plurality of splices.

### SUMMARY

Various examples of the present disclosure can overcome various of the aforementioned and other disadvantages associated with known splice chips and offer new advantages as well.

According to one aspect of various examples of the present disclosure there is provided a holding device that has a first row of arms and a second row of arms.

According to one aspect of various examples of the present disclosure there is provided a splice chip that has a first row of arms and a second row of arms.

According to one aspect of various examples of the present disclosure there is provided a holding device having a first flexible arm for retaining a first splice and a second flexible arm for retaining a second splice. The first flexible arm is movable independently of the second flexible arm.

According to one aspect of various examples of the present disclosure there is provided a splice chip having a first flexible arm for retaining a first splice and a second flexible arm for retaining a second splice. The first flexible arm is movable independently of the second flexible arm.

According to one aspect of various examples of the present disclosure there is provided a holding device having a body that extends along an axis. The body includes a first arm disposed on a first side of the axis and a second arm disposed on a second side of the axis. The first arm is movable independently of the second arm.

According to one aspect of various examples of the present disclosure there is provided a splice chip having a body that extends along an axis. The body includes a first arm disposed on a first side of the axis and a second arm disposed on a second side of the axis. The first arm is movable independently of the second arm.

According to one aspect of various examples of the present disclosure there is provided a holding device with a first arm and a second arm. The first arm is formed as a cantilever member and is tapered toward the first free end in a first direction. The second arm is formed as a cantilever member and is tapered toward the second free end in a second direction.

According to one aspect of various examples of the present disclosure there is provided a splice chip with a first arm and a second arm. The first arm is formed as a cantilever member and is tapered toward the first free end in a first direction. The second arm is formed as a cantilever member and is tapered toward the second free end in a second direction.

According to another aspect of various examples of the present disclosure, there is provided a holding device that includes a body that extends along a longitudinal axis, a first plurality of retainer arms, and a second plurality of retainer arms. The first plurality of retainer arms is arranged in a first row and disposed on a first side of the longitudinal axis. Each arm of the first plurality of retainer arms includes a first upper edge and a first lower edge. The second plurality of retainer arms is arranged in a second row and disposed on a second side of the longitudinal axis. Each arm of the second plurality of retainer arms includes a second upper edge and a second lower edge. A free end of the first lower edge of each arm of the first plurality of retainer arms is disposed a first distance from a surface of the body and a free end of the second lower edge of each arm of the second plurality of retainer arms is disposed a second distance from the surface of the body that is less than the first distance. Each arm of the second plurality of retainer arms can move from a first position to a second position to accommodate a first article. Each arm of the first plurality of retainer arms can move from a third position to a fourth position to accommodate a second article. The movement of each arm of the first plurality of retainer arms between the first position and the second position is independent of the movement of each arm of the second plurality of retainer arms between the third position and the fourth position.

According to another aspect of various examples of the present disclosure, there is provided a holding device that includes a body that extends along a longitudinal axis, a first plurality of retainer arms, and a second plurality of retainer arms. The first plurality of retainer arms is arranged in a first row and disposed on a first side of the longitudinal axis. Each arm of the first plurality of retainer arms includes a first upper edge and a first lower edge. The second plurality of retainer arms is arranged in a second row and disposed on a second side of the longitudinal axis. Each arm of the second plurality of retainer arms includes a second upper edge and a second lower edge. The first lower edge of each arm of the first plurality of retainer arms is inclined relative to a surface of the body and second lower edge of each arm of the second plurality of retainer arms is substantially parallel to the surface of the body. Each arm of the first plurality of retainer arms can move from a first position to a second position to accommodate a first article. Each arm of the second plurality of retainer arms can move from a third position to a fourth position to accommodate a second article. The movement of each arm of the first plurality of retainer arms between the first position and the second position is independent of the movement of each arm of the second plurality of retainer arms between the third position and the fourth position.

According to another aspect of various examples of the present disclosure, there is provided a holding device that includes a body that extends along a longitudinal axis, a first plurality of retainer arms, and a second plurality of retainer arms. The first plurality of retainer arms is arranged in a first row and disposed on a first side of the longitudinal axis. Each arm of the first plurality of retainer arms includes a first upper edge and a first lower edge. The second plurality of retainer arms arranged in a second row and disposed on a second side of the longitudinal axis. Each arm of the second plurality of retainer arms includes a second upper edge and a second lower edge. The first lower edge of each arm of the first plurality of retainer arms is inclined relative to a surface of the body and second upper edge of each arm of the second plurality of retainer arms is inclined relative to the surface of the body, and wherein the first lower edge and the second upper edge are parallel to one another when viewed in cross section. Each arm of the first plurality of retainer arms can move from a first position to a second position to accommodate a first article. Each arm of the second plurality of retainer arms can move from a third position to a fourth position to accommodate a second article. Movement of each arm of the first plurality of retainer arms between the first position and the second position is independent of the movement of each arm of the second plurality of retainer arms between the third position and the fourth position.

According to one aspect of various examples of the present disclosure there is provided a method of connecting a splice to a splice chip. The method includes inserting a first splice into a first section of the splice chip and inserting a second splice into the first section of the splice chip. A first arm of the splice chip may contact the first splice and a second arm of the splice chip may contact the second splice.

According to one aspect of various examples of the present disclosure there is provided a method of using a holding device. The method includes connecting the holding device to a cable enclosure and inserting a first article into a first receiving section of the holding device formed proximate to a first retaining arm and a second retaining arm. The second retaining arm can flex from a first position to a second position to allow receipt of the first article. The method further includes inserting a second article into the first receiving section. The first retaining arm can flex from a third position to a fourth position to allow receipt of the second article. The first retaining arm is movable between the first position and the second position independently of the second retaining arm moving between the third position and the fourth position.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompanying drawing wherein:

FIG. 1 is a perspective view of a splice chip for use with a cable management device.

FIG. 2 is a top view of the splice chip of FIG. 1.

FIG. 3 is a bottom view of the splice chip of FIG. 1.

FIG. 4 is a side view of the splice chip of FIG. 1.

FIG. 5 is a front view of the splice chip of FIG. 1.

FIG. 6 is a cross-sectional view of the splice chip of FIG. 2, viewed along section 6-6.

FIG. 7 is a perspective view of the splice chip of FIG. 1 being assembled into a cable management device.

FIG. 8 is a perspective view of the splice chip of FIG. 1 coupled to the cable management device.

FIG. 9 is a perspective view of splices coupled to the splice chip.

### DETAILED DESCRIPTION

The present disclosure relates to a holding device or splice chip 100 for use in retaining multiple splices (e.g., fiber splices). The splice chip 100 may be used with an enclosure in which splices may be retained. In particular, the splice chip 100 may be a multi-row splice chip that can accommodate a plurality of splices. However, the splice chip 100 may alternatively be used to retain other objects (e.g., any article which may or may not be a cable).

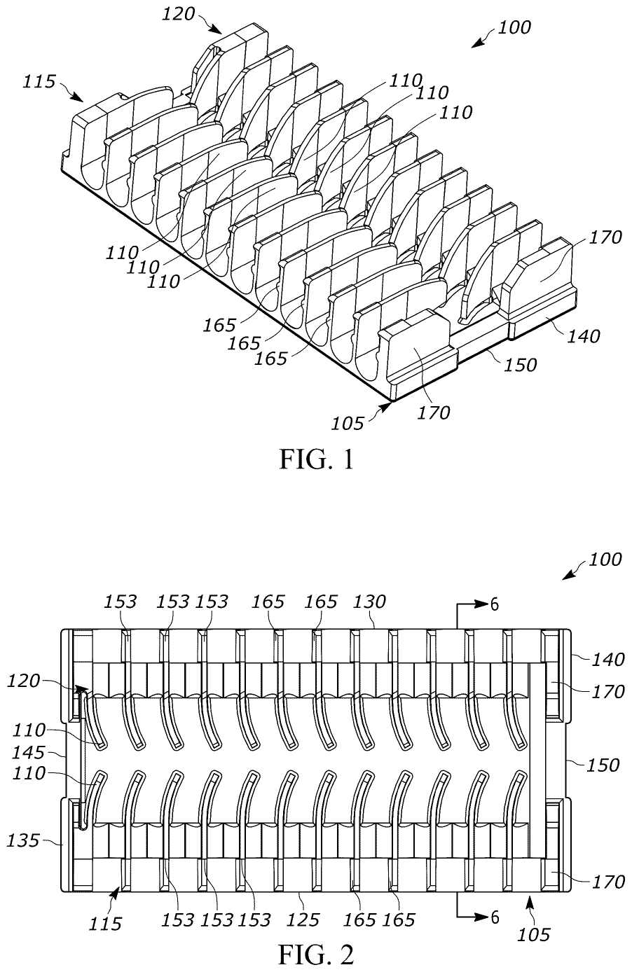

As shown in FIG. 1, the splice chip 100 may include a body 105 with a plurality of retainers or arms 110. In the illustrated example, the arms 110 may be arranged in a first row 115 and a second row 120, which may be adjacent to the first row 115.

In some forms, the first row 115 and the second row 120 may be parallel to one another along the length of the body 105. The first row 115 and the second row 120 may also extend the same length, although other examples may include a first row 115 that is longer or shorter than the second row 120.

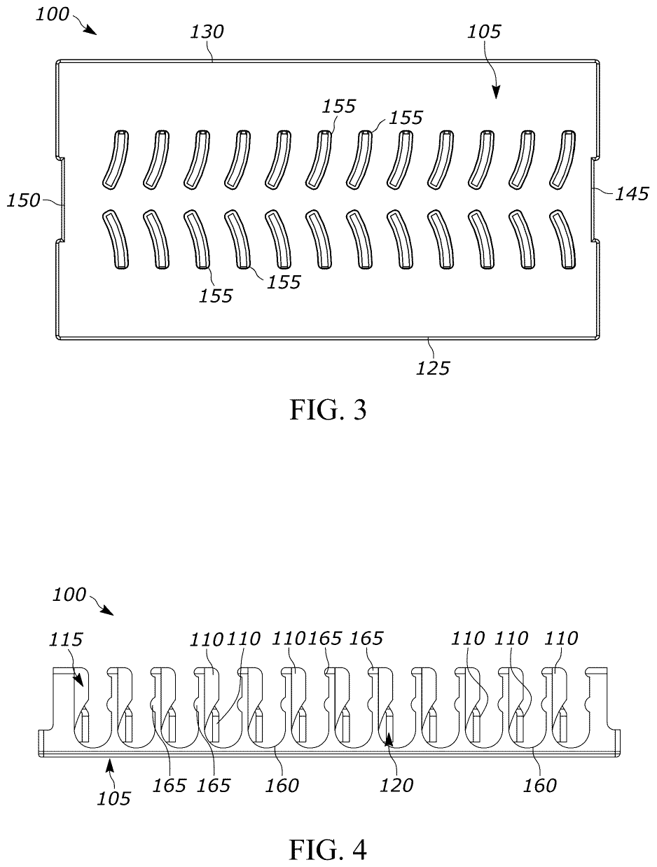

As shown in FIGS. 2 and 3, the illustrated body 105 of the splice chip 100 may be substantially rectangular in shape. The first and second rows 115, 120 may extend parallel a first and second edge 125, 130 of the body 105. The first and second edges 125, 130 may be longer than perpendicular third and fourth edges 135, 140. Although in other examples, the first and second rows 115, 120 may extend parallel to the shorter edges 135, 140 (or all of the edges may be equal to one another).

As shown in FIG. 2, the body 105 may include a first fastening section 145 and a second fastening section 150. The first fastening section 145 may be disposed on the third edge 135 and the second fastening section 150 may be disposed on the fourth edge 140, although any arrangement may be used including the fastening sections 145, 150 positioned on one or more different edges and/or a different number of fastening sections 145, 150.

In some forms, each fastening section 145, 150 may be a cutout section. For example, the fastening sections 145, 150 may have an outer edge that is radially inside of the respective third and fourth edges 135, 140. In other examples, the fastening sections 145, 150 may be projections that extend from the respective third and fourth edges 135, 140 (or any other edge).

With continued reference to FIG. 2, the arms 110 may be formed as cantilever members that extend toward a center of the body 105. For example, the free end of the arms 110 in the first row 115 may be disposed proximate to the free end of the arms 110 in the second row 120. The free ends of the arms 110 on the first row 115 may be at least partially spaced apart from the free ends of the arms 110 on the second row 120.

In some forms, each arm 110 is coupled (e.g., integrally formed) with a support 153 that extends from the surface of the body 105. For example, each support 153 may be oriented substantially perpendicularly with respect to the surface. The fixed end of each arm 110 may be connected to an edge of the support 153 and the free end of that arm 110 may extend away from the respective support 153.

In the illustrated example, each arm 110 may have a substantially similar curvature along its respective length between the fixed and free ends. Although in other examples, one or more of the arms 110 may have a different curvature (e.g., the arms 110 in the first row 115 have a different curvature than the arms 110 in the second row 120).

In some forms, the body 105 may be substantially symmetrical about an axis that extends parallel to the first and second edges 125, 130 between the free ends of the first and second rows 115, 120 when viewed from the top. In this form, the free end of a first arm 110 on the first row 115 may be substantially co-planar (e.g., about a plane perpendicular to the axis of symmetry) to a free end of a second arm 110 on the second row 120 across from the first arm 110.

As shown in FIG. 3, an opening 155 may extend through a surface of the body 105. In the illustrated example, the openings 155 may be arranged in two rows similar to the arrangement of the arms 110. Additionally, the openings 155 may include a curved shape that may correspond to the shape of the arms 110. For example, each arm 110 may extend over a respective one of the openings 155.

As shown in FIGS. 4 to 6, the arms 110 in the first row 115 may be disposed at a different height that the arms 110 in the second row 120. For example, the arms 110 of the first row 115 may be further from a surface of the body 105 than the arms 110 of the second row 120. Each of the arms 110 in a given row may be at a constant height, although examples may include one or more arms 110 in a given row at a different height than the other arms 110 in the same row.

As shown in FIG. 4, the space between adjacent arms 110 in the same row 115, 120 may be substantially U-shaped. For example, there may be a substantially curved shape 160 between adjacent arms 110. Other examples may include another shape (e.g., a V-shape). In some forms, the shape of the curvature may substantially correspond to the shape of a splice to be retained by the respective arm 110. The illustrated arms 110 may be equally spaced so that the arc length of each curved section is substantially the same. In other examples, one or more of the arms 110 may be spaced apart at a different distance so that the curvature between the arms 110 may vary (e.g., to accommodate different sized splices).

In certain forms, the arms 110 may extend substantially vertically from the curved section 160. The width of the curved section 160 may be the maximum width of the space between adjacent arms 110, although the arms 110 may be angled relative to one another in other examples.

In some forms, one or more detents 165 may be formed on a surface of the support 153. The illustrated supports 153 each include a pair of rounded detents 165, although other examples may include a different number of detents 165 (e.g., zero, one, three, etc.) and/or the detents 165 may have a different shape (e.g., angled). In still other examples, one or more of the detents 165 may be formed on a surface of an arm 110 (e.g., instead of and/or in addition to a detent 165 formed on the support 153).

The arms 110 in both the first and second rows 115, 120 may include detents 165 that project into the curved section 160. The detents 165 may be positioned at the same height relative to the surface of the body 105 on the arms 110 of both the first and second rows 115, 120.

In some forms, each arm 110 includes a pair of spaced apart detents 165. One detent 165 may be disposed proximate to a middle of the respective arm 110 and the other detent 165 may be disposed proximate to an upper end of the respective arm 110. The distance between the surface of the body 105 and the lower detent 165 may be approximately the same distance as between the lower detent 165 and the upper detent 165. This distance may be approximately the size of a splice 25.

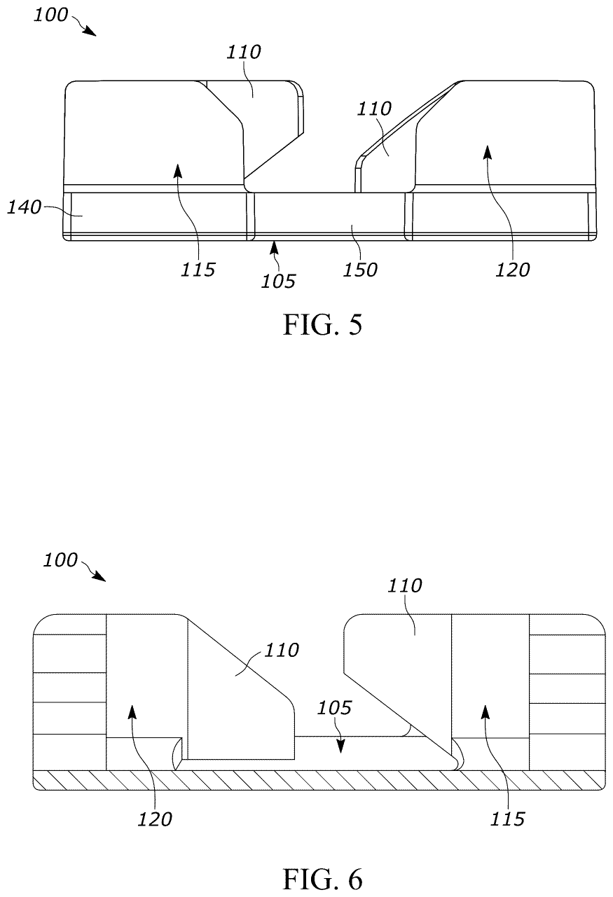

As shown in FIGS. 5 and 6, one or more of the arms 110 may be tapered along its respective length toward the free end. For example, arms 110 in the first row 115 may taper in an upward direction (e.g., as viewed in FIGS. 5 and 6) and arms 110 in the second row 120 may taper in the downward direction. In other words, a distance between each arm 110 of the first row 115 and the surface of the body 105 may increase toward the free end of the respective arm 110. A distance between each arm 110 in the second row 120 and the surface of the body 105 may remain substantially constant.

In certain forms, the incline of the arms 110 in the first row 115 may be substantially the same as the incline of the arms 110 in the second row so that the free ends of each of the arms 110 may be substantially the same height (e.g., measured as a distance between the respective upper and lower edges).

In some forms, the incline in each arm 110 may limit the overlap of the arms 110 on opposing rows 115, 120. For example, the incline in the various arms 110 may permit the arms 110 to move without contacting the opposing arm 110 on the other row. As described in more detail below, arms 110 on the first row 115 may flex because of contact with a splice without contacting the arms 110 in the second row 120. Additionally, the arms 110 of the second row 120 may similarly flex because of contact with a splice without contacting the arms 110 in the first row 115. The supports 153 may be fixed and may not move or flex with the respective arms 110.

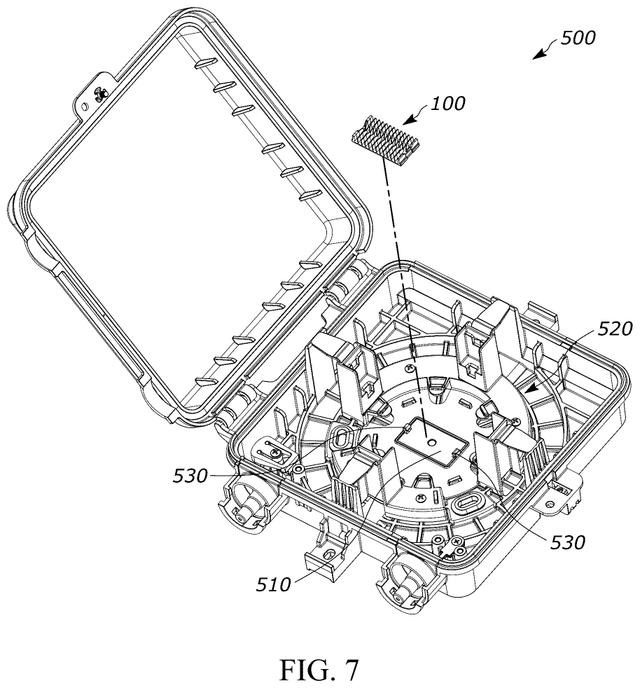

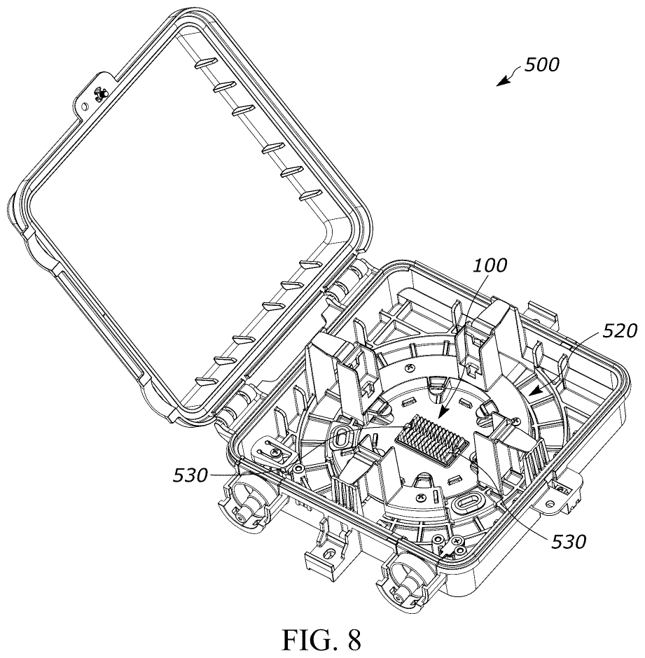

As shown in FIGS. 7 and 8, the splice chip 100 may be inserted into an enclosure 500. For example, the splice chip 100 may be connected (e.g., directly or indirectly) at the back surface 510 of the enclosure 500 on a cable spool 520. In the illustrated form, the enclosure 500 may include fixed tabs 530. The splice chip 100 can fit under the fixed tabs 530.

In other examples (not shown), the splice chip 100 may be secured to the back surface 510 with a different mechanical fastener (e.g., a screw, a rivet, etc.), an adhesive (e.g., double-sided tape), or any similar fastener. In still other examples, the splice chip 100 may be integrally formed to the back surface 510.

In some forms, the splice chip 100 may be constructed from a flexible material (e.g., a plastic like injection molded polycarbonate). For example, the body 105 may be substantially thin to permit bending or flexion along the length of the body 105. When the splice chip 100 is inserted into the enclosure 500, the body 105 may be bent to permit the body 105 to fit between the tabs 530 (e.g., because a distance between the tabs 530 is less than a maximum length of the body 105). When the ends of the body 105 are under the respective tab 530 (e.g., closer to the back surface 510), a force on the body 105 may be released and the splice chip 100 may relax to an original position. In this position, the splice chip 100 may be disposed between the tabs 530 and the back surface 510. More specifically, the tabs 530 may extend into the respective fastening section 145, 150 to help retain the splice chip 100 in position.

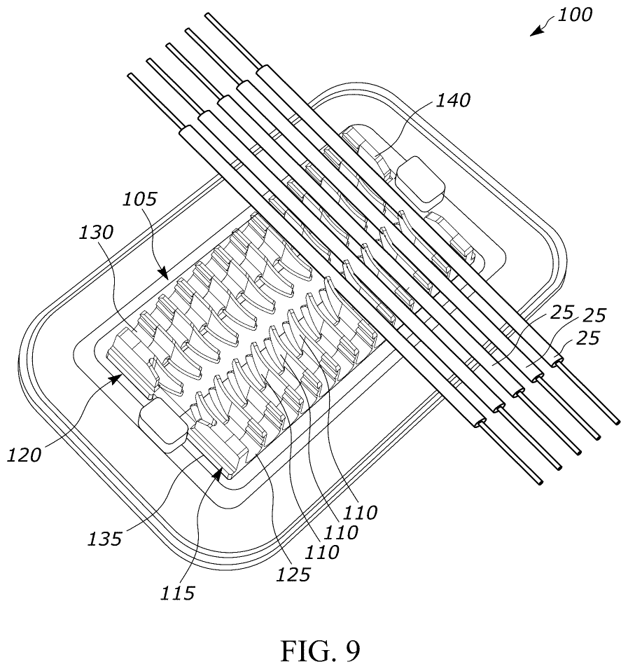

As shown in FIG. 9, splices 25 may be inserted into the splice chip 100. The illustrated splice chip 100 is separate from the enclosure 500, although the description may be equally applicable for the splice chip 100 coupled to the enclosure 500.

In some forms, a splice 25 may be inserted into a curved section 160 of the splice chip 100. The splice 25 may be fully inserted so that the splice 25 is in contact with or proximate to the surface of the body 105. As the splice 25 is inserted, it may move past the arm 110 of the first row 115 and contact the arm 110 of the second row 120 (e.g., the arm 110 proximate to the surface of the body 105). The arm 110 in the first row 115 may briefly deflect out of the neutral position as the splice 25 moves toward the arm 110 in the second row 120. The arm 110 in the first row 115 may return to its neutral position as the splice 25 moves into contact with and deflects the arm 110 in the second row 120.

In some forms, each arm 110 may be flexible and may move because of contact with the splice 25. For example, an individual arm 110 may move from a neutral position (see e.g., FIG. 2) to a biased position when a splice 25 is inserted into the splice chip 100. When the splice 25 is fully inserted, the arm 110 may exert a biasing force on the splice 25 toward the neutral position. This force may be applied laterally against the splice 25 to push the splice 25 against an adjacent arm 110, thereby retaining the splice 25 in position. Alternatively, the arms 110 at an end of the first and second rows 115, 120 may be adjacent to a fixed wall 170 (e.g., a planar wall that does not flex with the insertion of a splice 25). The biasing force of either of these end arms 110 may be applied laterally against the splice 25 to push the splice 25 against the respective fixed wall 170.

In some forms, the movement of any one arm 110 in the second row 120 may not affect the position of any arm 110 in the first row 115. As described above, an arm 110 in the first row 115 may not remain in a deflected position when the splice 25 moves past the first row 115 and into contact with an arm 110 in the second row 120. In some forms, the movement of an arm 110 in any one row 115, 120 may be independent from any other arm 110 in the same row 115, 120. In some forms, each arm 110 may be movable independently of every other arm 110 on the splice chip 100. When multiple splices 25 are inserted into the splice chip 100, the respective arm 110 may move independently to permit the splice chip 100 to accommodate splices 25 of different sizes.

In some forms, the detents 165 may assist in retaining a respective splice 25 within the curved section 160. For example, each detent 165 may extend toward a center of the curved section 160, thereby reducing the width of the curved section 160. As a splice 25 is inserted into a particular curved section 160, it moves past the upper detent 165 to a location between the upper and lower detents 165, and then moves past the lower detent 165. The arm 110 may flex to permit the splice 25 to pass toward the surface of the body 105 past the detents 165.

When the first splice 25 is inserted into a respective curved section 160, the lower detent 165 may assist in retaining the splice 25 between the surface of the body 105 and the lower detent 165. For example, distance between the detent 165 and the surface of the body 105 may be sized to receive the splice 25, and the detent 165 may limit the translational movement of the splice 25 out of the curved section 160. The arms 110 may need to flex to permit the splice 25 to move past the detent 165.

When a second splice 25 is inserted into a respective curved section 160, the splice 25 may be retained between the upper and the lower detents 165. For example, distance between the detents 165 may be sized to receive the splice 25, and the detent 165 may limit the translational movement of the splice 25 out of the curved section 160. The arms 110 may need to flex to permit the splice 25 to move past the detent 165.

With continued reference to FIG. 9, a splice 25 may be inserted into the splice chip 100 on top of an already inserted splice 25. For example, a splice 25 may be inserted into a curved section 160 after another splice 25 was previously inserted into the same curved section 160. As the second splice 25 is inserted, the first splice 25 may limit the vertical movement of the second splice 25 and prevent the second splice 25 from engaging the arm 110 of the second row 120. Instead, the second splice 25 may contact the arm 110 in the first row 115. As described above, this arm 110 may flex out of the neutral position and provide a biasing force to retain the second splice 25 in place. The arm 110 in the first row 115 may move independently of the arm 110 in the second row 120 and without contacting the other splice 25.

In the illustrated example, the splice chip 100 may include twelve arms 110 in each row 115, 120. Thus, the splice chip 100 may be able to accommodate up to twenty-four splices 25. In other examples, the splice chip 100 may have a different size (e.g., different number of rows, different number of arms, etc.) and may accommodate a different maximum number of splices 25.

When installed in the enclosure 500, the splice chip 100 may be retained in position (e.g., substantially fixed from translating in a vertical or horizontal direction) by the fixed tabs 530. The splices 25 may be connected to the splice chip 100 and may also be substantially fixed. Additionally, coupling or decoupling a splice 25 from the splice chip 100 may not cause the splice chip 100 to be disconnected from the enclosure 500.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

1. A holding device comprising:
a body extending along a longitudinal axis;
a first plurality of retainer arms arranged in a first row and disposed on a first side of the longitudinal axis, wherein each arm of the first plurality of retainer arms includes a first upper edge and a first lower edge; and
a second plurality of retainer arms arranged in a second row and disposed on a second side of the longitudinal axis, wherein each arm of the second plurality of retainer arms includes a second upper edge and a second lower edge;
wherein a free end of the first lower edge of each arm of the first plurality of retainer arms is disposed a first distance from a surface of the body and a free end of the second lower edge of each arm of the second plurality of retainer arms is disposed a second distance from the surface of the body that is less than the first distance;
wherein each arm of the second plurality of retainer arms is configured to move from a first position to a second position to accommodate a first article;
wherein each arm of the first plurality of retainer arms is configured to move from a third position to a fourth position to accommodate a second article; and
wherein movement of each arm of the second plurality of retainer arms between the first position and the second position is independent of the movement of each arm of the first plurality of retainer arms between the third position and the fourth position.

2. The holding device of claim 1, wherein the first plurality of retainer arms and the second plurality of retainer arms each include twelve arms.

3. The holding device of claim 1, wherein the second upper edge of each arm of the second plurality of retainer arms is tapered from a respective fixed end to the respective free end that is narrower than the respective fixed end.

4. The holding device of claim 1, wherein the first lower edge of each arm of the first plurality of retainer arms is tapered from a respective fixed end to the respective free end that is narrower than the respective fixed end.

5. The holding device of claim 1, wherein each arm of the first plurality of arms is curved along its length in a first rotational direction, and wherein each arm of the second plurality of arms is curved along its length in a second rotational direction opposite to the first rotational direction.

6. The holding device of claim 1, wherein the body includes a first cutout that is configured to receive a retaining tab.

7. A holding device comprising:
a body extending along a longitudinal axis;
a first plurality of retainer arms arranged in a first row and disposed on a first side of the longitudinal axis, wherein each arm of the first plurality of retainer arms includes a first upper edge and a first lower edge; and
a second plurality of retainer arms arranged in a second row and disposed on a second side of the longitudinal axis, wherein each arm of the second plurality of retainer arms includes a second upper edge and a second lower edge;
wherein the first lower edge of each arm of the first plurality of retainer arms is inclined relative to a surface of the body and second lower edge of each arm of the second plurality of retainer arms is substantially parallel to the surface of the body;
wherein each arm of the first plurality of retainer arms is configured to move from a first position to a second position to accommodate a first article;
wherein each arm of the second plurality of retainer arms is configured to move from a third position to a fourth position to accommodate a second article; and
wherein movement of each arm of the first plurality of retainer arms between the first position and the second position is independent of the movement of each arm of the second plurality of retainer arms between the third position and the fourth position.

8. The holding device of claim 7, wherein the first plurality of retainer arms and the second plurality of retainer arms each include twelve arms.

9. The holding device of claim 7, wherein the second upper edge of each arm of the second plurality of retainer arms is substantially parallel to the first lower edge of each arm of the first plurality of retainer arms when viewed in cross section.

10. The holding device of claim 7, wherein the first upper edge of each arm of the first plurality of retainer arms is substantially parallel to the first lower edge of each arm of the second plurality of retainer arms when viewed in cross section.

11. The holding device of claim 7, wherein each arm of the first plurality of retainer arms is curved along its length in a first rotational direction, and wherein each arm of the second plurality of retainer arms is curved along its length in a second rotational direction opposite to the first rotational direction.

12. The holding device of claim 7, wherein the body includes a first cutout that is configured to receive a retaining tab.

13. The holding device of claim 7, wherein the body includes a first plurality of apertures aligned with the first plurality of retainer arms, and wherein the body includes a second plurality of apertures aligned with the second plurality of retainer arms.

14. A method of using a holding device, the method comprising:
connecting the holding device to an enclosure;
inserting a first article into a first receiving section of the holding device formed proximate to a first retaining arm and a second retaining arm, wherein the second retaining arm is configured to flex from a first position to a second position to allow receipt of the first article; and
inserting a second article into the first receiving section, wherein the first retaining arm is configured to flex from a third position to a fourth position to allow receipt of the second article;
wherein the first retaining arm is movable between the first position and the second position independently of the second retaining arm moving between the third position and the fourth position.

15. The method of claim 14, wherein the holding device includes a first cutout, the method further comprising positioning the first cutout to receiving a first retaining tab of the enclosure to connect the holding device to the enclosure.

16. The method of claim 14, further comprising inserting a third article into a second receiving section formed proximate to a third retaining arm and a fourth retaining arm, wherein the third retaining arm is configured to flex from a fifth position to a sixth position to allow receipt of the third article.

17. The method of claim 16, wherein the third retaining arm is movable between the fifth position and the sixth position independently of the first retaining arm and the second retaining arm.

18. The method of claim 14, wherein the first retaining arm is curved along its length in a first rotational direction, and wherein the second retaining arm is curved along its length in a second rotational direction opposite to the first rotational direction.

19. The method of claim 14, wherein a free end of a first lower edge of the first retaining arm is disposed a first distance from a surface of the holding device and a free end of a second lower edge of the second retaining arm is disposed a second distance from the surface of the holding device that is less than the first distance.

20. The method of claim 14, wherein a first lower edge of the first retaining arm is tapered from a first fixed end to a first free that is narrower than the first fixed end, and wherein a second upper edge of the second retaining arm is tapered from a second fixed end to a second free that is narrower than the second fixed end.

21.-26. (canceled)
